(19) United States
(12) Patent Application Publication
(10) Pub. No.: US 2018/0216043 A1
(43) Pub. Date: Aug. 2, 2018

(54) Cleaning Composition

(71) Applicant: Whiteley Corporation Pty. Ltd., North Sydney (AU)

(72) Inventors: Trevor Owen Glasbey, Tanilba Bay (AU); Nicolas Alan Roberts, Cardiff South (AU); Gregory Stuart Whiteley, Queenscliff (AU); Reginald Keith Whiteley, Queenscliff (AU)

(73) Assignee: Whiteley Corporation Pty. Ltd., North Sydney (AU)

(21) Appl. No.: 15/886,872

(22) Filed: Feb. 2, 2018

(30) Foreign Application Priority Data
Feb. 2, 2017 (AU) 2017900319

(51) Int. Cl. C11D 3/48; C11D 3/382; C11D 3/37; C11D 3/33; C11D 3/20; C11D 3/00; C11D 1/14; C11D 1/74; C11D 11/00

(52) U.S. Cl. CPC C11D 3/48; C11D 3/382; C11D 3/3757; C11D 3/3715; C11D 11/0017; C11D 3/2037; C11D 3/0047; C11D 1/146; C11D 1/74; C11D 3/33

(57) ABSTRACT

The invention relates to an aqueous cleaning and/or sanitising composition comprising (a) at least one biocidal component (b) a polymeric delayed release additive, and (c) at least one surfactant, wherein said composition dries onto a surface being cleaned to form a dry residue and wherein properties of said dry residue are tailored by manipulation of brittleness of the polymeric delayed release additive through identity and/or quantity of the biocidal component and/or surfactant selected. The composition is intended for the cleaning and/or sanitisation of carpet, upholstery or other textiles. The invention also relates to a method of controlling the friability of the dried residue of the composition. The invention also relates to a method of cleaning and/or sanitising a textile article by applying the composition of the invention to said article, and a process of preparing said cleaning and/or sanitising composition.

### RELATED APPLICATION AND PRIORITY

The present application claims priority upon Australian Patent Application No. 2017900319 filed Feb. 2, 2017, the teaching and entire specification of which is expressly incorporated by reference.

### FIELD OF THE INVENTION

The invention relates to a composition intended for the cleaning and/or sanitisation of carpet, upholstery or other textiles.

### BACKGROUND OF INVENTION

Simple effective methods for the routine achievement of effective cleaning and disinfection of carpets and textile furnishings in domestic dwellings, healthcare facilities and commercial premises remains a major challenge for chemical formulators. This is demonstrated by the number of documents issued over the past several decades each describing attempts to formulate towards this important goal.

The present invention relates to textile disinfectant compositions, particularly disinfectant compositions for use with carpet, fabric or other textile surfaces.

The invention has been developed primarily for use as a cleaning and/or disinfecting composition for heavily soiled and contaminated household, commercial or institutional fabrics and will be described hereinafter with reference to this application. However, it will be appreciated that the invention is not limited to this particular field of use.

Contributing to the difficulties in researching acceptable technologies is the number of important variables routinely encountered in the market place. The ever-increasing range of synthetic textiles with specific surface chemistries, presale chemical treatments, designs, constructions and textures and variations in locations each contribute to difficulties facing chemical formulators. Types of traffic over textiles and the chemical and physical properties of soiling matter that will be expected to accumulate at each separate location, are also major chemical design factors to be considered.

A particular concern in the care of textiles, such as carpet and other soft furnishings, besides basic cleanliness, is reducing microbial contaminants to safe levels (sanitising) as determined by public health requirements. This is especially important in hospital and other health care facilities where the presence of unwanted bacteria may be detrimental to the health of recovering patients. Spore forming organisms pose a particular challenge due to their resistance to most common disinfection chemicals. The spore-forming organism Clostridium difficile (C. diff) in particular presents significant issues due to the resilience of the spores and the very low infective dose required for transmission. In carpeted facilities, such as aged care homes, disinfecting textiles that have been contaminated with C. diff can be exceedingly difficult.

The disinfection of heavily soiled and contaminated textiles is difficult for many reasons. The combination of wetness and organic soil which are commonly encountered provides an ideal nutrient medium for microbe growth such as algae, bacterial spores, moulds and other microbes. In addition, if the textile is exposed to soiling and odours from household animal deposits such as urine or faeces under conditions of minimal domestic hygiene, disinfection and deodorization present a major challenge because the deposits are associated with the formation of offensive odours and microbially active substances which remain in the fabric.

Therefore, the need exists for compositions which are capable of removing gross organic soiling and also preventing the growth of problematic microorganisms in carpet and other textiles.

Numerous biocides have been investigated for their potential for sanitisation of carpets and other soft furnishings such as aldehydes or aldehyde-releasing chemicals, halogens such as bromine, chlorine and iodine, oxidizing agents such as hydrogen peroxide, and low molecular weight alcohols such as ethanol and isopropanol. However, under practical conditions for household fabrics and soft floor coverings, all have serious practical limitations that restricts use by reasons such as toxicity and sensitisation (aldehydes), offensive odours (aldehydes, halogens and oxidising agents), the propensity for causing chemical burns (halogens), potential for fibre damage and/or dye reduction (oxidizing agents) or flammability (alcohols). These biocides also have a serious limitation in that they are suitable for the temporary sanitisation of textiles only and do not impart any residual biocidal activity to the treated articles.

Others have tried to solve some of these problems with the use of cationic biocides, however, these are often incompatible with the common stain resist treatments and also are prone to causing rapid resoiling of carpet if not completely removed by a subsequent extraction process. Cationic biocides, such as those described in U.S. patent application Ser. No. 13/984,558, were developed in an attempt to mitigate some of these issues, but can still exhibit incompatibilities with stain resist treatments.

While a number of the above materials may provide an appropriate temporary sanitizing effect, another important concern which these materials do not address is the presence of dirt-attracting residues, such as residual surfactants from the cleaning products used. Such residues allow carpet to quickly become unsanitary because of the soil and bacteria which may be attracted by the residue.

Conventional carpet and upholstery cleaning solutions typically contain high loadings of non-ionic surfactants intended to solubilise and disperse contaminates and soil from the surface. Any residual surfactant which is not fully removed from the fibres during subsequent rinsing remains present on the fibre surface. The oily nature of these residues causes the fibres to become more sensitive to re-soiling than fibres which had not been subjected to the cleaning process. These residues also often lead to undesirable changes in the texture, feel or softness of the carpet or upholstery surface. Because of the propensity for these residues to lead to resoiling, it is normal practice to extract said residues from the carpet using hot water or similar.

Numerous compositions have been described in the art which attempt to mitigate these issues through the use of surfactants with lower propensity for re-soiling along with the inclusion of polymers intended to reduce the tackiness of the dried cleaning solution residue. These compositions, however, do not exhibit the longevity of biocidal activity necessary for the treatment of heavily soiled areas such as those that can be found in areas that have been exposed to significant levels of microbial contamination.

In circumstances with high degrees of microbial contamination, it is highly desired for a composition capable of generating a residual layer on the textile for an extended period of time that will prevent the growth of microorganisms. This can be particularly important in areas where textiles have remained damp for extended periods. This residual semi-permanent layer can therefore prevent any remaining organisms from proliferating and also prevent subsequent recolonisation after the textile is returned to service.

Surprisingly it has been found that through careful selection of biocide, surfactant and suitable polymeric delayed release additives, it is possible to tailor the brittleness of the dried residue following application of the present invention to a textile. Without wishing to be bound by theory, it is thought that the polymeric delayed release additive is plasticized by the biocide, thus making it less brittle. The plasticization of the polymeric delayed release additive also serves to slow down the evaporation of the biocide, thus also controlling its release. In the context of this invention therefore, the polymeric delayed release additive is functioning as a delayed release additive. For the purposes of this document the terms “polymeric delayed release additive” may be regarded as synonymous with the term “delayed release polymer”.

The present invention may be formulated to allow for the biocide to plasticize the brittle polymeric delayed release additive and therefore generate a semi-permanent treatment for the textile that will not easily undergo adhesive failure from the textile fibres. Alternatively, the present invention may be formulated with a relatively volatile biocide that will plasticize the polymeric delayed release additive but during the later stages of drying will evaporate from the textile. This will increase the brittleness of the dried residue and allow it to fracture from the carpet fibres and be removed by routine cleaning. The present invention allows for the tailoring of the brittleness of the dried residue to be manipulated depending on the desired characteristics of the formulation.

Traditional carpet cleaning processes typically involve the use of steam or hot water extraction steps in order to remove soiling and reduce the level of residual cleaning compound present on the carpet surface following cleaning. This process requires the use of bulky and expensive truck mounted extraction machines and also adds significant levels of moisture to the carpet. This added moisture can contribute to the growth of microorganisms on the freshly cleaned carpet.

The quantity of water added to the carpet is such that some compositions, such as those described in U.S. patent application Ser. No. 10/904,504, have included fungicides to prevent the development of fungal growth due to the large quantities of water applied to the carpet substrate. Hot water extraction is also a time consuming and labour-intensive method of cleaning. Therefore, it is highly desirable for products of this nature to have a sufficiently low propensity for resoiling for hot water extraction to be unnecessary whilst also imparting the semi-permanent antimicrobial layer.

It would be desirable to provide a biocidal composition that imparts a semi-permanent preventative layer to prevent the regrowth/recolonisation of microorganisms on the textile surface. It would also be desirable to provide a composition that does not contribute to the formation of dirt attracting residues and can also be used without the hot water extraction equipment necessary for traditional textile cleaning methods.

A reference herein to a patent document or other matter which is given as prior art is not to be taken as an admission that that document or matter was known or that the information it contains was part of the common general knowledge as at the priority date of any of the claims.

### SUMMARY OF INVENTION

According to a first embodiment of the present invention there is provided an aqueous cleaning and/or sanitising composition comprising:

a. at least one biocidal component,

b. a polymeric delayed release additive, and

c. at least one surfactant;

wherein said composition dries onto a surface being cleaned to form a dry residue and wherein properties of said dry residue are tailored by manipulation of brittleness of the polymeric delayed release additive through identity and/or quantity of the biocidal component and/or surfactant selected.

According to a second embodiment of the invention there is provided a method of controlling friability of dried residue of a cleaning and/or sanitising composition comprising:

a. at least one biocidal component,

b. a polymeric delayed release additive, and

c. at least one surfactant;

by manipulation of identity and/or quantities of the biocidal component, polymeric delayed release additive and surfactant.

According to a third embodiment of the invention there is provided a method of cleaning and/or sanitising a textile article by applying the composition according to the first embodiment to said article.

According to a fourth embodiment of the invention there is provided a process of preparing a cleaning and/or sanitising composition by dilution of a concentrate

a. at least one biocidal component;

b. a polymeric delayed release additive; and

c. at least one surfactant

wherein properties of dried residue of the composition are tailored by manipulation of brittleness of the polymeric delayed release additive through identity and/or quantity of the biocidal component and/or surfactant selected.

There is also provided a cleaning and/or sanitising composition according to the first embodiment capable of generating a semi-permanent antimicrobial residual layer on treated textiles.

There is also provided a cleaning and/or sanitising composition according to the first embodiment where the composition is used as a delivery vehicle for secondary components such as miticides, fungicides, odour absorbing compounds, animal repellents or insect repellents.

There is also provided a cleaning and/or sanitising composition according to the first embodiment where the composition includes a spore germinant.

Throughout the description and claims of the specification, the word “comprises” and variations of the word, such as “comprising” and “comprises”, is not intended to exclude other additives, components, integers or steps.

### DETAILED DESCRIPTION OF THE INVENTION

In accordance with the present invention there is provided an aqueous cleaning and/or sanitising composition comprising:

a. at least one biocidal component,

b. a polymeric delayed release additive, and;

c. at least one surfactant;

wherein said composition dries onto a surface being cleaned to form a dry residue and wherein properties of said dry residue are tailored by manipulation of brittleness of the polymeric delayed release additive through identity and/or quantity of the biocidal component and/or surfactant selected.

pH

The pH of the compositions generally affects biocidal action, and the preferred pH will vary depending on the particular biocidal components utilised in the composition. For example, phenolic biocides are at their most biocidal when present in their unionised form and a neutral to mild acid pH would be preferable. Phenolic compounds used in an alkaline medium are also more susceptible to oxidation. For cationic biocides, a mildly alkaline pH (about 7-9) is preferable due to their increased biocidal performance in this range.

The selection of pH also generally affects compatibility with the textile type that is to be treated. For example, for the cleaning of wool, the high level of alkalinity of woollen blends or silk textiles can cause significant degradation of the textile fibres. In a more preferred embodiment the pH of the composition is mildly acidic in the range of about 5.5 to 7.0 to allow for the composition to be used for the cleaning of a wide range of carpet or upholstery fibres including those which are sensitive to high levels of alkalinity. Other embodiments may be contemplated that have higher pH values, for example in the range of about 9-11 if their use is only intended for use on non-alkalinity sensitive fibres such as polyamide or polyolefin.

Biocidal Component

The composition of the invention comprises at least one biocidal component. In a preferred embodiment, the combination of biocidal components is stable and maintains its antimicrobial activity during and following the drying of the composition onto the textile substrate. In a particularly preferred embodiment the biocidal components may reduce the brittle nature of the polymeric delayed additive, such that adhesive failure from the textile surface due to the physical forces experienced during the textile's normal use, is significantly reduced. In a particularly preferred embodiment, when used in conjunction with the polymeric delayed release additive and surfactant, the biocidal components are capable of generating a semi-permanent antimicrobial prevention layer on treated textiles.

In a preferred embodiment, the biocidal component is selected from the group consisting of one or more aliphatic or cycloaliphatic terpenes, an aromatic or phenolic biocide and combinations thereof. In a particularly preferred embodiment the biocidal component is selected from the non-limiting group consisting of thymol, carvacrol, eugenol, menthol, terpineol, carvone, citral and combinations thereof. In another preferred example the biocidal component is a synthetically derived phenolic compound such as o-phenylphenol, 2-benzyl-4-chlorophenol or chloroxylenol.

In a further aspect of the invention the biocidal component may be in the form of an essential oil such as the essential oils of cloves, thyme, fennel, caraway, peppermint, lemon myrtle, tea tree or combinations thereof. In a preferred embodiment, a synergistic combination of thymol and carvacrol are used. In a highly preferred embodiment, phenolic biocides are used in combination with a biocidal essential oil.

Alternatively, or in addition, biocidal components that may act as crosslinking agents may be employed to increase the hardness of the polymeric delayed release additive to tailor the friability of the dried residue into the desired range. In a preferred embodiment, the crosslinking biocidal agent is a transition metal salt. In a particularly preferred embodiment the crosslinking biocidal agent is a zinc salt.

The total quantity of the biocidal components will be largely dependent on the antimicrobial activities of the selected components, the degree of soiling of the textile articles to be treated and if the composition is intended to be diluted prior to use. Preferably the biocidal components are present in the composition at a concentration of about 0.01 to 10% w/w of the composition, more preferably at a concentration of about 0.05 to 5% w/w, even more preferably at a concentration between about 0.1 to 2% w/w of the composition.

Polymeric Delayed Release Additive

The composition of the invention comprises at least one polymeric delayed release additive that functions as a polymeric delayed release additive. The least one polymeric delayed release additive is selected from either a water soluble anionic acrylic based copolymer or styrene maleic anhydride resin which, on drying, will result in a non-tacky solid. In a preferred embodiment, the polymeric delayed release additive will form a brittle film upon drying.

Preferably the polymeric delayed release additives are present in the composition at a concentration of about 0.5 to 30% w/w of the composition, more preferably at a concentration of about 1.0 to 15% w/w, even more preferably at a concentration between about 2 to 10% w/w of the composition.

Preferred examples are the aqueous solutions of acrylic acid/methacrylic acid copolymers sold under the trade name Syntran 4020, Syntran 4180 and Syntran 4125, all available from Interpolymer Corporation. Another preferred example is Flexisperse 305 (Innovative Chemical Technologies Inc.). Other polymeric agents will include styrene maleic anhydride copolymers such as described in U.S. Pat. No. 3,835,071.

Typically, within the prior art, these materials find utility as anti-redeposition polymers. An example of this may be found in U.S. patent application Ser. No. 13/778,208 (published as US 2014/0100153) which utilises a styrene maleic anhydride copolymer as an anti-redeposition agent. As described within the '208 teaching, the function of the anti-redeposition agent is to facilitate sustained suspension of soils in a cleaning solution and prevent the removed soils from being redeposited onto the substrate being cleaned.

Surfactant

The composition of the invention includes at least one surfactant. Preferably the surfactant selected is capable of solubilising the biocidal components to form a water white, single phase composition. More preferably the surfactant should be capable of modifying the friability of the polymeric delayed release additive in conjunction with the biocidal components. Anionic surfactants are preferred due to foaming characteristics, tackiness of dried residue and compatibility with stain resist treatments, although embodiments based on non-ionic, cationic and amphoteric are equally envisioned. In a preferred embodiment, the surfactant is selected from the group consisting of alkyl sulfates, alkyl ether sulfates, alkyl benzene sulfonates, alkyl naphthalene sulfonates, alkyl sulfonates, alkyldiphenyloxide disulfonates and combinations thereof. In a preferred embodiment, the surfactant used is sodium dodecyl sulfate. In a particularly preferred embodiment, a combination of anionic and amphoteric surfactants is used.

Preferably the surfactants are present in the composition at a concentration of about 0.5 to 30% w/w of the composition, more preferably at a concentration of about 1.0 to 15% w/w, even more preferably at a concentration between about 1.5 to 10% w/w of the composition.

Secondary Components

In a further aspect of the invention the composition acts as a carrier for secondary compositions appropriate for the control or management of household pests, mites or other biological fouling. Embodiments of the invention may also be suitable for the repellence of insects, arachnids or animals as required. In a preferred embodiment, the composition of the present invention may serve as a vehicle or carrier for the transport of secondary compositions appropriate for the control of household pests, mites etc. These secondary compositions are envisioned to be able to be carried in the present invention without compromising the biocidal activity of the present invention.

Examples of such secondary compositions are miticides such as benzyl alcohol and benzyl benzoate, odour absorbing compounds such as cyclodextrins or zinc ricinoleate, dog or cat repelling compounds such as 2-undecanone, insect repellent compounds such as dimethyl phthalate or fungicides such as phenoxyethanol or potassium sorbate.

In a preferred embodiment, secondary components will be present in the formulation in an amount between about 0.1 to 5% w/w of the composition of the invention. In a more preferred embodiment the secondary components will be present in the formulation in an amount between about 0.1 and 1.0% w/w of the composition.

Bacterial Spore Germinant

In a further aspect of the invention the composition may also contain a bacterial spore germinant. The inclusion of a spore germinant causes exposed bacterial spores to germinate into the vegetative state and therefore be more susceptible to the action of the biocidal components. Examples of suitable spore germinants which may be used in the composition of the invention are dodecylamine and other alkylamines, L-alanine, L-valine, L-asparagine and bile acids.

In a highly preferred embodiment the composition may include the sodium, potassium or amine salt of a bile acid as a C. difficile spore germinant. In a particularly preferred embodiment the bile acid spore germinant may be selected from the group consisting of sodium cholate, sodium taurocholate, sodium glycocholate, sodium deoxycholate and mixtures thereof.

Given that these bile acids may also function as surfactants, it is envisaged that some embodiments may only contain these bile acids with no additional surfactant within the formulation.

In a preferred embodiment, the spore germinant is present in the formulation in an amount between about 0.001 to 2% w/w of the composition. In a more preferred embodiment the spore germinant is present in the formulation in an amount between about 0.005 to 1.0% w/w of the composition

### EXAMPLES

The following examples are manufactured by dissolving and mixing the various ingredients into deionised water at room temperature. Each ingredient is dissolved to yield a clear solution before the next ingredient is added. A portion of the water (up to 50%) may be withheld in the initial phase of manufacture and added when all of the ingredients are dissolved if necessary. More concentrated examples may require the hydrophobic components to be first solubilised in a surfactant premix as would be obvious to a person skilled in the art.

TABLE 1
Weight Percentages of Actives

| Ingredient | Example 1 | Example 2 | Example 3 | Example 4 |
|---|---|---|---|---|
| SLS | 1.5 | — | — | 2.0 |
| 2A1 | — | 1.5 | — | — |
| BAK | — | — | 4.0 | — |
| 916 | — | — | — | 2.0 |
| PCMX | — | 0.5 | — | 2.0 |
| TTO | 0.5 | — | 2.5 | 1.0 |
| CAR | 0.2 | — | 1.6 | — |
| THY | 0.2 | — | — | — |
| OPP | — | 0.2 | — | — |
| SYN | 2.5 | — | 20.0 | — |
| SMA | — | 2.5 | — | 15.0 |
| H₂O | To 100% | To 100% | To 100% | To 100% |

LEGEND
SLS—Sodium Lauryl Sulphate
2A1—Alkyldiphenyloxide Disulfonate
916—Linear (C9-C11) alcohol ethoxylate 6 mol ethylene oxide
PCMX—Chloroxylenol
PMO—Peppermint Oil
BAK—Benzalkonium Chloride
TTO—Tea Tree Oil
CAR—Carvacrol
THY—Thymol
OPP—ortho-phenylphenol
SYN—Syntran 4125
SMA—Styrene Maleic Anhydride Copolymer

The pH of Examples 1-4 may be adjusted with either sodium hydroxide or citric acid to be within the desired range.

Examples 1 and 2 are intended to be ready-to-use compositions. The compositions of Examples 3 and 4 may be diluted prior to use. The extent of the dilution will vary according to the nature and concentration of active ingredient in the particular formula and the degree of fouling on the particular textile. Dilutions of up to 50 to 1 can be made with the more concentrated products, e.g. Example 3, in situations where the soiling on the textile is minimal or where the composition is being applied as a preventative treatment.

More specialised formulations may be prepared from the preceding formulation to incorporate secondary compounds such as insect/animal repellents, odour absorbing compounds or miticides. In these cases, the main formulation may serve as a carrier for the secondary compounds. Examples of these modified formulations are as follows:

### Example 5—Added Miticide

The formulation of Example 1 is modified by the addition of a readily dispersible solution of miticides, benzyl alcohol and benzyl benzoate.

PREMIX A. 0.5 g of benzyl benzoate is mixed with 0.5 g benzyl alcohol and 1.5 g sodium lauryl sulphate. This is dissolved, if need be, with gentle warming.

2.5 g of PREMIX A is added very slowly to 100 g of Example 1 under strong agitation. The resulting solution is mixed for a minimum of 30 minutes at room temperature. The solution is checked for stability and such other quality control characteristics as required.

### Example 6—Added Odour Neutraliser

The formulation of Example 4 is modified by the addition of a readily dispersible solution of the odour absorbing compound zinc ricinoleate.

PREMIX B. 25.0 g of Example 4 is diluted with 100.0 g deionised water while stirring. To this solution is added 5.0 g of Tegosorb A30 while stirring. Stirring is continued for 30 minutes until a clear, homogenous product is obtained. The pH of the sample is adjusted to the range of 7-9 using sodium hydroxide. The solution is checked for stability and other quality control characteristics as required.

### Example 7—Included Spore Germinant

The formulation of Example 2 is modified by the addition of a spore germinant. In this example, sodium cholate, a germinant for the spores of Clostridium difficile is used.

0.01 g of sodium cholate is added to 100 g of Example 2 with stirring under strong agitation. The resulting solution is mixed for a minimum of 30 minutes at room temperature. The solution is checked for stability and such other quality control characteristics as required.

### Alternative Embodiments

In the following examples, a crosslinking biocide is used to increase the friability of the dried residue either in isolation or in combination with other biocidal species. In these embodiments, sodium lauryl sulphate is used as the surfactant and Syntran 4125 is used as the polymeric delayed release additive.

TABLE 2
Weight Percentages of Actives

| | | |
|---|---|---|
| Water | 95.5 | 94 |
| Zinc Chloride | 0.5 | 0.5 |
| Sodium Lauryl Sulphate | 1.5 | 2.5 |
| Carvacrol | — | 0.5 |
| Syntran 4125 | 2.5 | 2.5 |

1. An aqueous cleaning and/or sanitising composition comprising:
a. at least one biocidal component,
b. a polymeric delayed release additive, and;
c. at least one surfactant;
wherein said composition dries onto a surface being cleaned to form a dry residue and wherein properties of said dry residue are tailored by manipulation of brittleness of the polymeric delayed release additive through identity and/or quantity of the biocidal component and/or surfactant selected.

2. A composition according to claim 1, wherein the biocidal component is selected from the group consisting of one or more aliphatic or cycloaliphatic terpenes, an aromatic or phenolic biocide and combinations thereof.

3. A composition according to claim 2, wherein the biocidal component is selected from the group consisting of thymol, carvacrol, eugenol, menthol, terpineol, carvone, citral and combinations thereof.

4. A composition according to claim 1 also comprising a biocidal essential oil.

5. A composition according to claim 4, wherein the biocidal essential oil is selected from the group consisting of the essential oils of cloves, thyme, fennel, caraway, peppermint, lemon myrtle, tea tree and combinations thereof.

6. A composition according to claim 1, wherein the biocidal component acts as a crosslinking agent of the polymeric delayed release additive.

7. A composition according to claim 6, wherein the crosslinking biocidal component is a transition metal salt.

8. A composition according to claim 1, wherein the biocide is present at a concentration of between about 0.01 to 10% w/w of the composition.

9. A composition according to claim 8, wherein the biocidal component is present at a concentration of between about 0.1 and 2.0% w/w of the composition.

10. A composition according to claim 1, wherein the polymeric delayed release additive is selected from a water soluble acrylic polymer/copolymer or styrene-maleic anhydride resin.

11. A composition according to claim 10, wherein the polymeric delayed release additive dries to a friable powder or brittle film.

12. A composition according to claim 1, wherein the polymeric delayed release additive is present at a concentration of between about 0.5 to 30.0% w/w of the composition.

13. A composition according to claim 12, wherein the polymeric delayed release additive is present at a concentration of between about 2.0 to 10.0% w/w of the composition.

14. A composition according to claim 1, wherein the surfactants are selected from the group consisting of anionic, cationic, non-ionic and amphoteric surfactants.

15. A composition according to claim 14, wherein the surfactant is selected from the group consisting of alkyl sulfates, alkyl ether sulfates, alkyl benzene sulfonates, alkyl naphthalene sulfonates, alkyl sulfonates, alkyldiphenyloxide disulfonates and combinations thereof.

16. A composition according to claim 1, wherein the surfactant is present at a concentration of between about 0.5 to 30.0% w/w of the composition.

17. A composition according to claim 16, wherein the surfactant is present at a concentration of about 1.5 to 10.0% w/w of the composition.

18. A composition according to claim 1, wherein the composition has a pH in the range of about 5.0 to 9.0.

19. A composition according to claim 18, wherein the composition has a pH in the range of about 5.5 to 7.0.

20. A composition according to claim 1, wherein the composition also contains a bacterial spore germinant.

21. A composition according to claim 20, wherein the bacterial spore germinant is selected from the group consisting of dodecylamine, L-alanine, L-valine, Lasparagine and a bile acid salt.

22. A composition according to claim 1, wherein the composition also contains an insect/animal repellent, odour absorbing compound or miticide.

23. A composition according to claim 1 which generates a semi-permanent antimicrobial coating on treated textile articles.

24. A method of controlling friability of dried residue of a cleaning and/or sanitising composition comprising:
a. at least one biocidal component,
b. a polymeric delayed release additive, and
c. at least one surfactant;
by manipulation of identity and/or quantities of the biocidal component, polymeric delayed release additive and surfactant.

25. A method of cleaning and/or sanitising a textile article by applying the composition according to claim 1 to said article.

26. A process of preparing a cleaning and/or sanitising composition, comprising combining:
a. at least one biocidal component,
b. a polymeric delayed release additive, and
c. at least one surfactant;
to form a concentrate, wherein properties of dried residue of the composition are tailored by manipulation of brittleness of the polymeric delayed release additive through identity and/or quantity of the biocidal component and/or surfactant selected.

27. A process according to claim 26 comprising diluting said concentrate with water.
